(19) United States
(12) Patent Application Publication
(10) Pub. No.: US 2026/0131625 A1
(43) Pub. Date: May 14, 2026

(54) LOW ENERGY HVAC SYSTEM FOR A VEHICLE AND METHOD OF OPERATING THE SAME

(71) Applicant: FCA US LLC, Auburn Hills, MI (US)

(72) Inventor: Mark J Skynar, Auburn Hills, MI (US)

(21) Appl. No.: 18/947,244

(22) Filed: Nov. 14, 2024

(51) Int. Cl. B60H 1/00

(52) U.S. Cl. CPC B60H 1/00742; B60H 1/00814

(57) ABSTRACT

A method and system for operating a climate control system of determining positions of occupants within a passenger compartment of a vehicle, determining occupant settings, communicating the positions and the occupant settings to an energy determination system, determining a low energy combination of climate control elements to achieve the occupant settings, generating control signals for the low energy combination of climate control elements and operating the combination of climate control elements with the control signals.

### FIELD

The present disclosure relates to a vehicle heating, ventilation and cooling (HVAC) system for a vehicle, and, more specifically, to a method of and system for operating the same.

### BACKGROUND

This section provides background information related to the present disclosure which is not necessarily prior art.

Battery electric vehicles use electrical power to both heat and cool the passenger compartment. The amount of power used may be a significant percentage of the overall electric power consumed during the driving cycle for both winter and summer ambient temperatures. Reducing the amount of power consumed by a vehicle and, in particular, an electric vehicle could increase the range for the electric vehicle. In one example, it was determined a 10 percent reduction in power resulted in a 3 percent increase in range.

### SUMMARY

This section provides a general summary of the disclosure, and is not a comprehensive disclosure of its full scope or all of its features.

The present system and method reduce the amount of energy used in the vehicle by determining a low energy combination of climate control elements.

In one aspect of the disclosure, a method for operating a climate control system includes determining positions of occupants within a passenger compartment of a vehicle, determining occupant settings, communicating the positions and the occupant settings to an energy determination system, determining a low energy combination of climate control elements to achieve the occupant settings, generating control signals for the low energy combination of climate control elements and operating the combination of climate control elements with the control signals.

In another aspect of the disclosure, a system includes occupant sensors generating position signals corresponding to positions of occupants within a passenger compartment of a vehicle. A controller receives occupant settings and positions. The controller comprises an energy determination system determining a low energy combination of climate control elements to achieve the occupant settings and generating control signals for the low energy combination of climate control elements. The combination of climate control elements operating in response to the control signals.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagrammatic view of a vehicle having the system according to the present disclosure.

FIG. 2A is a high level block diagrammatic view of the climate control system.

FIG. 2B is a block diagrammatic view of the occupant sensor of FIG. 2A.

FIG. 2C is a chart showing energy/power consumption for various components with the blower at different speeds.

FIG. 3 is a flow chart of a method for controlling various climate control elements.

Corresponding reference numerals indicate corresponding parts throughout the several views of the drawings.

### DETAILED DESCRIPTION

Example embodiments will now be described more fully with reference to the accompanying drawings.

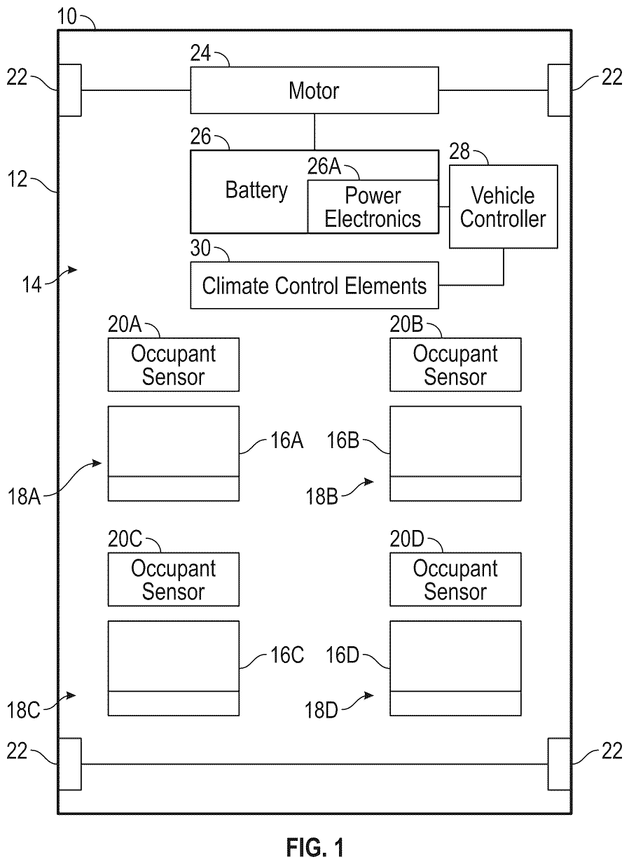

Referring now to FIG. 1, a vehicle 10 is illustrated having a body 12 that defines a passenger compartment 14. The passenger compartment 14 has several seating positions 16A-16D that define potential positions 18A-18D for occupants. In prior known vehicles, the seating positions may or may not be considered for the climate control settings. When they are considered, a simple temperature control is provided. When an occupant is not present, the last setting is used by the system even though there is no one in that position. However, in the present disclosure, the position of the occupants is taken into consideration. The positions 18A-18D may or may not have occupants therein. The presence or absence of occupants is determined by the occupant sensors 20A-20D. By detecting the presence of occupants at the positions 18A-18D, the climate control system components and setting for the components may reduce the amount of energy directed to unoccupied areas within the passenger compartment 14 of the vehicle 10.

The vehicle 10 also includes wheels 22 that are used to move the vehicle 10 in a forward direction. The vehicle 10 also includes an electric motor 24. The electric motor 24 is shown coupled to the front wheels 22. However, one or more motors 24 may be used in other locations of the vehicle. When multiple motors are used, they may be located at each wheel 22 or may be located at one or both axles of the vehicle 10.

The vehicle 10 also includes a high voltage battery 26 that includes the power electronics 26A. The power electronics 26A are used for controlling the output of power to the electrical drive components such as the motor 24 and controlling charging of the battery 26.

The vehicle 10 also includes a vehicle controller 28. The vehicle controller 28 may control various functions of the vehicle. Although one vehicle controller 28 is illustrated, a number of vehicle controllers 28 may be used within a vehicle. Climate control elements 30 are in communication with the vehicle controller 28. The climate control elements 30 may also include their own controllers. The climate control elements 30 may include various elements that are described in greater detail below. The climate control elements 30 are used for controlling the microclimates at the positions 18A-18D of the occupants. While four positions 18A-18D are illustrated, various numbers of positions 18 may be provided in a vehicle from one or two positions to various numbers of positions like 15 in an extended multi passenger van.

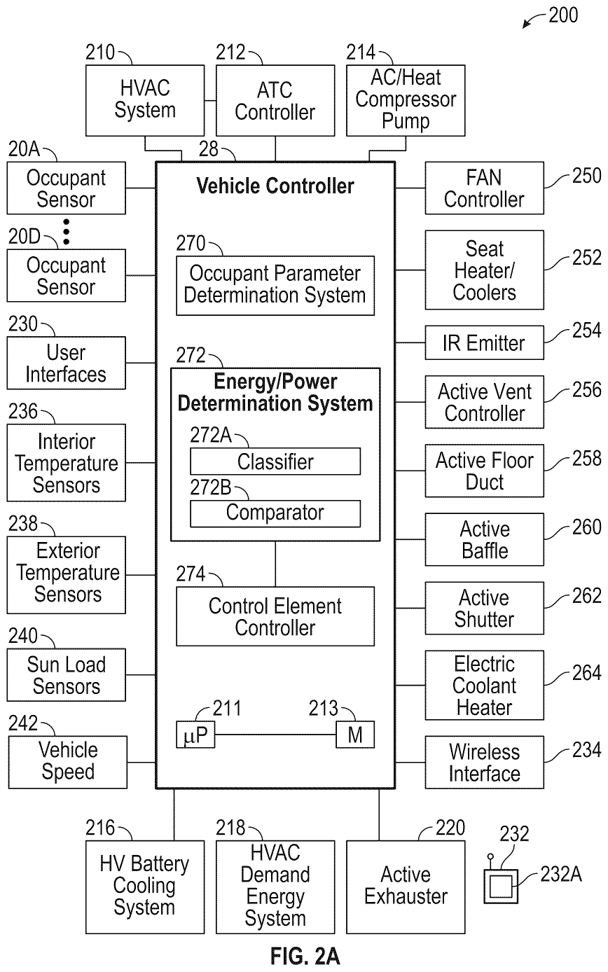

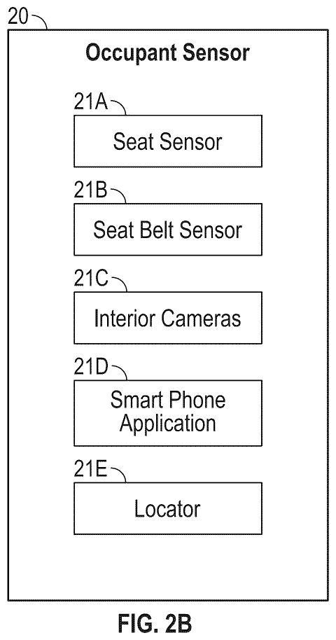

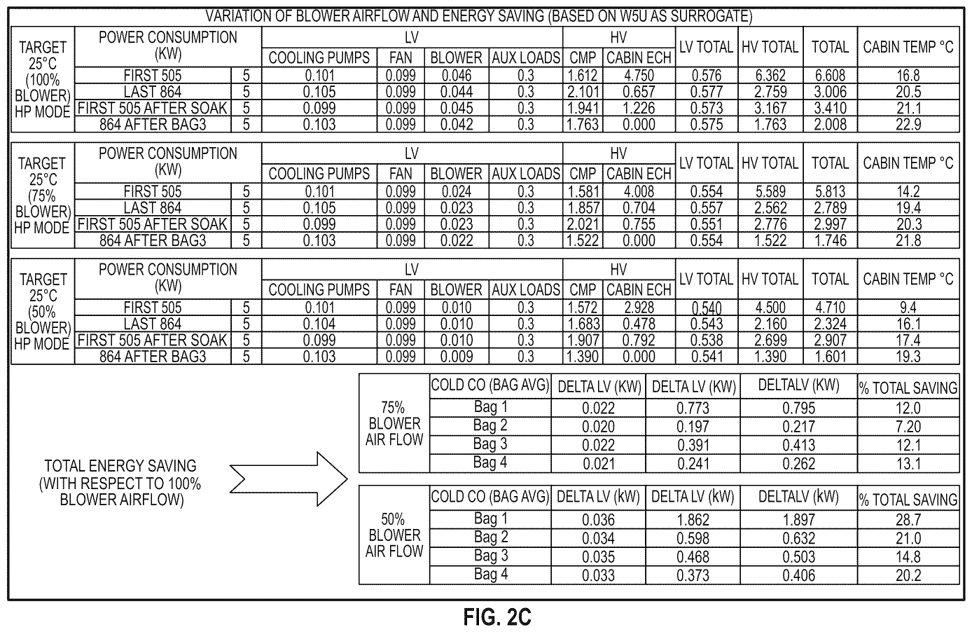

Referring now to FIG. 2A, a high level block diagrammatic view of a climate control system 200 includes a vehicle controller 28 having the climate control elements 30 coupled thereto is set forth. The vehicle controller 28 is coupled to various systems and devices throughout the vehicle 10 to determine control signals for the various climate control elements. The vehicle controller 28 includes a microprocess 211 and a memory 213. The microprocessor 210 may be referred to as a processor. The memory 213 is a non-transitory computer-readable medium that includes machine readable instructions that are executable by the processor 210. The machine-readable instructions include various signals that are used for controlling the various climate control elements.

The climate control elements include a HVAC system 210. The HVAC system 210 has various functions including heating and cooling of the passenger compartment of the vehicle. An automatic temperature controller 212 is in communication with the vehicle controller 28 and the HVAC system 210. The automatic temperature controller 212 controls the desired temperature of the passenger compartment for the climate control system to seek. An AC/heat compressor pump 214 may be in communication with the vehicle controller 28. The compressor pump 214 is used in conjunction with the HVAC system 210 to heat or cool air to ultimately cool the passenger compartment 14 of the vehicle 10 of FIG. 1.

The vehicle controller 28 may also be in communication with a high voltage battery cooling system 216, a HVAC demand energy system 218 and an active exhauster 220. The high-voltage (HV) battery cooling system 218 is used to control the temperature within the high voltage battery 26 of FIG. 1. The battery cooling system 218 may include a heat exchanger for providing energy to or from the high voltage battery 26.

The HVAC demand energy system 218 is illustrated as a stand-alone system but may be a control system for the compressor mode door and the like. The active exhauster 220 may be used to exhaust air from the passenger compartment 14 directly to outside of the vehicle 10.

The vehicle controller 28 may also be in communication with user interfaces 230. The user interfaces 230 may include buttons, dials, touch screens and the like. The user interface 230 may also include a touch screen display 232A on a mobile device 232 that communicates with the vehicle controller through a wireless interface 234. The wireless interface 234 may be used as an occupant sensor as well as an interface to the touch screen display 232A providing input to the vehicle controller 28.

Interior temperature sensors 236 may also be in communication with the vehicle controller 28. A number of interior temperature sensors 236 may be located throughout the passenger compartment of the vehicle 10. The interior temperature sensors 236 may include at least a temperature sensor for each of the positions 18A-18D for occupants of the vehicle. The interior temperature sensors 236 may include multiple sensors in each position. For example, a temperature sensor 236 may be located at the positions 18A-18D near the floor, the mid-section of the vehicle and the upper section of the vehicle. That is, the positions of the feet, torso and head levels of the occupants at the positions 18A-18D may be used.

One or more exterior temperature sensors 238 may be located at the exterior of the vehicle. The exterior temperature sensors 238 may be located in various places such as on various components such as mirrors or other components. The exterior temperature sensors 238 generate an exterior temperature signal that corresponds to the ambient air temperature outside of the vehicle.

A sunload sensors 240 may be disposed within the vehicle. The sunload sensors 240 sense the amount of sunload at various locations within the vehicle. By providing sunload sensor 240, the sunload signal may indicate to the vehicle controller 28 that more cooling is required at an occupant position 18 when sun is being directed whereto. As the vehicle moves direction the sun may impinge on different positions within the vehicle.

The climate control system may also be affected by the vehicle speed. Therefore, a vehicle speed sensor 242 may be used to determine a low energy combination of elements. The combination is a group of climate control elements that are controlled to achieve the results. For different vehicles, not all of the climate control elements may be used.

A fan controller 250 may also be used in the system. The fan controller 250 is used to control the speed of the air within the ducts of the system.

Seat heaters/coolers 252 may also be disposed within the vehicle. The seat heaters/coolers 252 are used to heat or cool selected areas of each of the occupant positions 18A-18D such as providing air through the perforations in the seat.

Vehicle controller 28 may also be coupled to an infrared (IR) emitter 254. The infrared emitter 254 may be disposed in various locations of the vehicle. Multiple infrared emitters 254 may be used in the passenger compartment. The IR emitter 254 may be used to selectively heat different areas within the passenger compartment.

An active vent controller 256 may also be incorporated into the system. The active vent controller 256 is used to control the opening and closing of active vents (air outlets) within the vehicle.

Active floor ducts 258 may also be coupled to the vehicle controller 28. The active floor duct 258 may have actuated louvers that may be actuated in various ways including mechanical coupling. The active vent controller 256 and the active floor duct 258 may be open, closed or directed in various directions to occupants within the vehicle to heat or cool them.

An active baffle 260 may also be coupled to the vehicle controller 28. The active baffle 260 may be used to open or close a baffle within the ducting of the vehicle and therefore selectively control the air flow before reach the vents.

An active shutter 262 may also be used in the system. The active shutter 262 is used to open or closed to prevent air from moving from outside the vehicle to cool components within the vehicle. Active shutters 262 in a battery electric vehicle may be used to help cool the battery and associated components.

The vehicle controller 28 may also include an occupant parameter determination system 270. The occupant parameter determination system 270 determines the occupant parameters within the vehicle including the location of the occupants and the requested settings for the level of temperature required by the occupant. The occupants within the vehicle may request different temperatures to form microclimates within the passenger compartment of the vehicle.

An energy determination system 272 is used to determine the amount of energy (or power) for the various climate control elements of the vehicle 10. The climate control elements 200 include, but are not limited to, the various elements 200 and 210-262 coupled to the vehicle controller 28. The energy determination system 272 determines a load energy combination of climate control elements that are used to achieve occupant settings. The occupant settings may be one of the parameters that are determined in the occupant parameter determination system 270. That is, various combinations of climate control elements could be used to achieve certain occupant settings. However, when all of the different settings are compared with each other, a low energy combination of climate control elements may be used to attempt to achieve the climate settings.

A control element controller 274 receives the low energy combination of climate control elements that achieve the occupant settings. Control signals are generated for controlling the operation of the various climate control elements.

The occupant parameter determination system 270 receives inputs from the user interface 230, the interior temperature sensors 236, the exterior temperature sensor 238, the sunload sensors 240 and vehicle speed sensors 242. The occupant positions and the various inputs from the occupant sensors are occupant settings that are communicated to the energy or power determination system 272. A plurality of groups for the climate control elements to achieve the occupant settings may be determined. The low energy combination of control elements is selected. Ultimately to achieve the desired occupant settings, control element controller 274 generates control signals to various systems such as the HVAC system 210, the automatic temperature control system 212, the AC/heat compressor pump 214, the fan controller 250, the seat heater/coolers 252 to control the seat temperature, the IR emitter 254, the active vent controls 256, the active floor duct 258, the active baffles 260 and active shutters 262 to achieve the settings by controlling the power to the components, controlling the direction and controlling the opening or closing of various components. In addition, the control element controller 274 may also control the high voltage battery cooling system 216, the HVAC demand energy 218 and the active exhauster 220. The amount of energy of each of the elements mentioned previously may be determined experimentally and therefore the memory 212 may store the amount of energy used by each of the devices for different settings. For example, the fan speed may be changed by changing the current to the fan controller 250 to achieve various fan speeds.

The determination of the low energy or power combination of elements may be determined in different ways. For example, a trained classifier 272A may be incorporated into the energy/power determination system 272. The trained classifier 272A may be trained with data during development of a vehicle. Data may include but is not limited to a model for the amount of energy used by each component, and a mathematical model for the comfort of exposed skin of the occupant. The trained classifier 272A may use a neural network to determine a low energy combination of climate control elements based on the models. The trained classifier 272A considerers many potential combinations of climate control elements therein but outputs a single lowest energy combination of components.

In another example, a comparator 272B may be incorporated into the energy/power determination system 272. The energy/power determination system 272 may determine the energy or power determinations energy combination of components The comparator 272B compares the amount of energy or power consumed by the various components and the lowest combination of climate control elements using the lowest amount of energy may be selected.

Once the lowest energy combination is determined, control signals are generated to control the components as mentioned above. The current level, on/off signals, motor control signals or the like are generated and used to control the components as mentioned above.

Referring now to FIG. 2B, more details of the occupant sensors 20 are illustrated. In this example, the occupant sensor 20 are illustrated in further detail.

The occupant sensor 20 is illustrated in further detail. The occupant sensor 20 may have a seat sensor 21A that is used to detect various aspects of the seat and therefore determine whether there is occupancy within the vehicle. The seat sensor 21a may sense an occupant at the seating positions 18A-18D. The occupant sensors include a seat sensor 21A that may have a load cell for determining the amount of weight on a seat within the vehicle. A seat belt sensor 21B is used to determined the occupants with seat belts therearound and therefore with the vehicle. An interior camera or cameras 21C may be used within the vehicle. The interior cameras may detect positions of the occupant.

A smart phone application 21D, as described above, may be in communication with the controller 28 as also set forth above.

FIG. 2C is a chart having power consumption for different blower percentages. In the first set of data, the power consumption for the first 504 seconds and the last 864 seconds is provided for various elements including the cooling pumps, the fan, the blower, the auxiliary loads, which are all low voltage loads. The high voltage loads, including the compressor and the electric coolant heater (ECH) is set forth. The total and the cabin temperature associate therewith are provided in the last column. The power consumption or “other soak” and “after bag 3” is also provided for each of the blower settings. The two boxes at the bottom of the chart show the percentage savings of the system when the power air flow is reduced to 75% or 50%. FIG. 2C is one example of a way to determine the power or energy consumption of a system. With computing power, various combinations may be generated when the load energy of climate control elements is selected. The 50% blower air flow saves the most energy (power) consumption. In this document, the reference is to energy. However, power is a measure of energy over time so therefore power corresponds to an amount of energy used by the components.

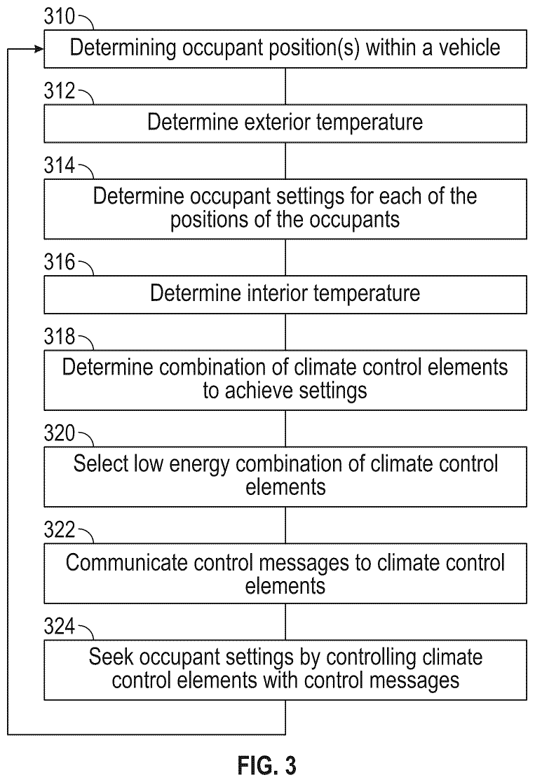

Referring now to FIG. 3, a high level method is illustrated for controlling the climate control elements. In step 310, the occupant positions within the vehicle are determined. Occupant sensors 20A-20D may be used alone or in combination determine the occupant positions. The occupant positions may be determined by one of the sensors illustrated in FIG. 2B. However, two or more occupant sensors may be provided. In step 312, the exterior temperature of the vehicle may be determined by the exterior temperature sensors 238 that generate exterior temperature signals. In step 314, the occupant settings for each of the positions of the occupants may be determined. The occupant settings may be provided through the user interfaces 230 located throughout the vehicle. A cell phone or another mobile device 232 may provide the settings for occupant. In step 316, the interior temperature signal for the locations of the occupant positions may be determined. The temperatures may be determined at various levels in the vehicle. That is, the temperature sensors may be spaced apart in various vertical positions. For example, temperature sensors may be located low within the vehicle to provide a temperature signal that corresponds to the temperature at the feet of the occupants. Likewise, a middle sensor may be set forth in the middle of the vehicle to determine the temperature at the torso of the occupants. A higher positioned sensor may be located high within the vehicle to generate a signal corresponding to the temperature near the face.

In step 318, the combination of control elements is determined in the energy determination system 272. That is, various numbers of climate control elements may be generated in a plurality of combinations. In step 320, the low energy combination of climate control elements is determined. That is, the various combinations may be generated and therefore a lowest energy combination may be selected. Ultimately, step 322 communicates control messages to the control elements to control the fan speeds and other devices as mentioned above. Ultimately, feedback is provided to the system. That is, the occupant settings are sought by controlling the elements with control messages generated in step 322.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. Steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
determining positions of occupants within a passenger compartment of a vehicle;
determining occupant settings;
communicating the positions and the occupant settings to an energy determination system;
determining a low energy combination of climate control elements to achieve the occupant settings;
generating control signals for the low energy combination of climate control elements; and
operating the combination of climate control elements with the control signals.

2. The method of claim 1 wherein determining the positions comprises determining the positions from an occupant sensor.

3. The method of claim 1 wherein determining the positions comprises determining the positions based on at least one of a seat sensor, a seat belt sensor, an interior camera, a smart phone application, and a locator.

4. The method of claim 1 wherein determining the positions comprises determining the positions based on at least two of a seat sensor, a seat belt sensor, an interior camera, a smart phone application, and a locator.

5. The method of claim 1 further comprising determining an interior temperature for each of the positions and wherein determining the low energy combination of climate control elements is based on the interior temperature.

6. The method of claim 1 further comprising determining an exterior temperature and wherein determining the low energy combination of climate control elements is based on the exterior temperature.

7. The method of claim 1 further comprising determining an exterior temperature and an interior temperature for each of the positions and wherein determining the low energy combination of climate control elements is based on the exterior temperature and the interior temperature for each of the positions.

8. The method of claim 1 wherein determining the occupant settings comprises determining the occupant settings for each of the positions.

9. The method of claim 8 wherein determining the occupant settings comprises determining an air temperature setting for each position.

10. The method of claim 8 wherein determining the occupant settings comprises determining an air temperature setting and seat temperature setting for each position.

11. The method of claim 1 wherein generating control signals comprises generating a first control signals for controlling a fan speed at a fan controller.

12. The method of claim 1 wherein generating control signals comprises generating control signals for controlling at least one of a fan speed, an infrared emitter, an active baffle, an active vent, an active shutter, a seat temperature, an active exhauster.

13. The method of claim 1 wherein generating control signals comprises generating control signals for controlling at least two of a fan speed, an infrared emitter, an active baffle, an active vent, an active shutter, a seat temperature, an active exhauster.

14. The method of claim 1 wherein determining the low energy combination of climate control elements to achieve the occupant settings comprises determining a plurality of combinations and selecting one of the plurality of combinations as the low energy combination.

15. A system comprising:
occupant sensors generating position signals corresponding to positions of occupants within a passenger compartment of a vehicle;
a controller receiving occupant settings and positions, the controller comprising an energy determination system determining a low energy combination of climate control elements to achieve the occupant settings and generating control signals for the low energy combination of climate control elements;
the combination of climate control elements operating in response to the control signals.

16. The system of claim 15 wherein the occupant sensors comprise at least one of a seat sensor, a seat belt sensor, an interior camera, a smart phone application, and a locator.

17. The system of claim 15 further comprising an interior temperature sensor for each of the positions and generating interior temperature signals and wherein the controller determines the low energy combination of climate control elements based on the interior temperature signals.

18. The system of claim 15 further comprising an exterior temperature sensor generating an exterior temperature signal and wherein determining the low energy combination of climate control elements is based on the exterior temperature signal.

19. The system of claim 15 wherein the controller generates control signals for controlling at least one of a fan speed, an infrared emitter, an active baffle, an active vent, an active shutter, a seat temperature, an active exhauster.

20. The system of claim 15 wherein the controller determines a plurality of low energy combinations of climate control elements to achieve the occupant settings by selecting one of the plurality of combinations as the low energy combination.
